(19) United States
(12) Patent Application Publication
(10) Pub. No.: US 2017/0043493 A1
(43) Pub. Date: Feb. 16, 2017

(54) SHEATH ASSEMBLY

(71) Applicant: FirstEdge, Inc., Orinda, CA (US)

(72) Inventors: Brett Philip Seber, Vista, CA (US); Wesley James Tom, Vista, CA (US)

(73) Assignee: FirstEdge, Inc.

(21) Appl. No.: 15/233,749

(22) Filed: Aug. 10, 2016

Related U.S. Application Data
(60) Provisional application No. 62/204,255, filed on Aug. 12, 2015.

(51) Int. Cl. B26B 29/02; A45F 5/02

(52) U.S. Cl. CPC B26B 29/025; A45F 5/021; B26B 3/00

(57) ABSTRACT

A knife sheath assembly that secures and protects a knife when subjected to harsh or rigorous conditions. The knife sheath assembly includes shims which add durability to the sheath assembly. The components of the sheath assembly are connected in such a way so as to allow broken or damaged parts to be replaced.

### RELATED APPLICATIONS

This application claims priority to U.S. Provisional Application Ser. No. 62/204,255, filed on Aug. 12, 2015.

### BACKGROUND OF THE INVENTION

The present invention generally relates to sheath assemblies. More specifically, the present invention is directed to an improved knife sheath assembly which has metal shims, adding to the durability of the sheath assemblies for use in military, hunting, or other similar settings, and is able to have broken or damaged parts replaced.

Knife sheaths are widely known in the art. The conventional knife sheath, whether made from leather, plastic, or metal, is designed to hold a knife and protect the blade from exposure so as to keep the blade in good condition and to allow the blade to be carried safely.

Plastic material, particularly Kydex or other thermoplastic material, has become popular for use in knife sheaths. One of the major advantages of using a thermoplastic material for knife sheaths is that it is durable. This is particularly helpful for military and hunting knives as a soldier or hunter is often crawling on the ground, moving through brush, or wading through water. Unlike a traditional leather sheath which would quickly dry up and crack when subjected to such conditions, a thermoplastic sheath will hold up much longer.

One problem with a thermoplastic sheath, especially a sheath that is folded as described above, is that the sheath may crack when subjected to cold conditions in combination with the other rigorous conditions it may be subjected to. Cracks in a thermoplastic sheath often cause the knife to become insecure in the sheath and the entire sheath consequently becomes unusable and must be replaced.

Accordingly, it would be advantageous to develop a sheath assembly which is able to keep the knife secured if the thermoplastic or other moldable material cracks and which is designed to have the broken parts replaced instead of having to replace the entire sheath. The present invention fulfills this need and provides other related advantages.

### SUMMARY OF THE INVENTION

The present invention resides in a sheath assembly, such as a knife sheath assembly which is designed to be advantageous for use in military, hunting and similar settings. The knife sheath assembly secures and protects the knife when subjected to harsh or rigorous conditions. The sheath assembly includes shims which add to the durability of the sheath assembly. Moreover, the components of the sheath assembly are connected in such a way so as to allow broken or damaged parts to be replaced. Although the following description and illustrations are particularly directed to a knife sheath assembly, it will be appreciated that the teachings of the invention can also be applied to sheath assemblies for other objects, including a holster or holder for tools, guns, and the like.

The sheath assembly of the present invention generally comprises at least one sheet of moldable material molded to a general configuration of the object to be removably inserted therein. In a particularly preferred embodiment, the material is molded to a general configuration of a blade and a guard of a knife so as to create contiguous knife blade and knife guard cavities for removably receiving the knife blade and the knife guard therein. The at least one sheet of material may comprise first and second sheets of moldable material. Alternatively, the sheet of material may comprise a single sheet of material folded and molded to create the knife blade and knife guard cavities. The one or more sheets of moldable material typically comprises thermoplastic material, such as Kydex which is a thermal plastic acrylic-polyvinyl chloride material or the like.

A drain channel may extend from the knife blade cavity to outside of the sheath assembly for removing debris and water from the knife blade cavity.

A series of spaced apart apertures are formed in the material adjacent to a peripheral edge thereof. Detachable fasteners extend through at least a plurality of the apertures. There may be fewer fasteners than apertures.

A shim may be disposed between layers of the material. The shim may have apertures alignable with the apertures of the material so as to receive the fasteners therethrough. The shims or liners may be comprised of a metal material, such as stainless steel. In the event that the moldable material cracks or breaks, the shim serves to retain the usability of the sheath assembly. The fasteners can be detached in order to allow for disassembly, cleaning, repair and/or replacement of materials, and reassembly in a quick and easy manner.

A normally closed hinge may be formed adjacent to the knife guard cavity that opens as the knife guard is inserted into or removed from the knife guard cavity. The hinge comprises adjacent flaps of material having aligned apertures and a fastener extending therethrough permitting separation of the flaps as the knife guard is inserted into or removed from the knife guard cavity. In this manner, the knife snaps securely into the sheath and may be removed with positive thumb pressure, ensuring safe carry as well as rapid and safe deployment.

A webbing assembly may be attachably connected to the molded material. The webbing assembly may have a loop for insertion of a belt. The webbing assembly, which may be comprised of a poly-pro nylon, may come in different sizes and allow the user to choose between higher and lower carry. The webbing assembly may include a connector for coupling a handle of the knife to the webbing assembly. The connector may comprise a strap detachably connecting the knife handle to the webbing assembly. Alternatively, or in addition to, the connector may comprise a magnet associated with the webbing assembly that couples a magnetically attractive portion of the knife handle to the webbing assembly. The magnetically attractive portion of the knife handle may comprise a corresponding magnet embedded therein.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a front perspective view of a knife sheath assembly embodying the present invention;

FIG. 2 is a rear perspective view of the knife sheath assembly of FIG. 1;

FIG. 3 is an exploded perspective view of the knife sheath assembly of FIGS. 1 and 2, illustrating the various components thereof, along with a knife;

FIG. 4 is a front plan view of the knife sheath of FIG. 3;

FIG. 5 is a side elevation view of the knife sheath of FIG. 4;

FIG. 6 is a front perspective view of a knife and a knife sheath assembly embodying the invention having a magnetic connector;

FIG. 7 is a front plan view of an alternate one sheet folded embodiment of the knife sheath assembly;

FIG. 8 is a top plan view of the alternate folded embodiment of FIG. 7;

FIG. 9A is a fractional perspective view of a knife being inserted into the knife sheath, in accordance with the invention; and

FIG. 9B is a fractional perspective view of a knife in place in the knife sheath.

### DETAILED DESCRIPTION OF THE PREFERRED EMBODIMENTS

As shown in the drawings, for purposes of illustration, the preferred embodiments of the present invention may be directed to an improved knife sheath assembly which is functionally advantageous for use in military, hunting, or other similar settings. Generally, the knife sheath assembly protects the blade of a knife and allows the knife to be carried safely. The sheath assembly is durable and preferably is designed in such a way so that broken or damaged parts may easily be replaced. The sheath may include panels or sheets of material molded to the shape of the knife, shims which add to the durability of the sheath, a drain channel to clear water and debris caught in the sheath, and screws which connect the sheath together and allow the user to configure the sheath for placement on a belt or military webbing and selectively disassemble the sheath assembly for cleaning and maintenance and/or repair and replacement of damaged components thereof.

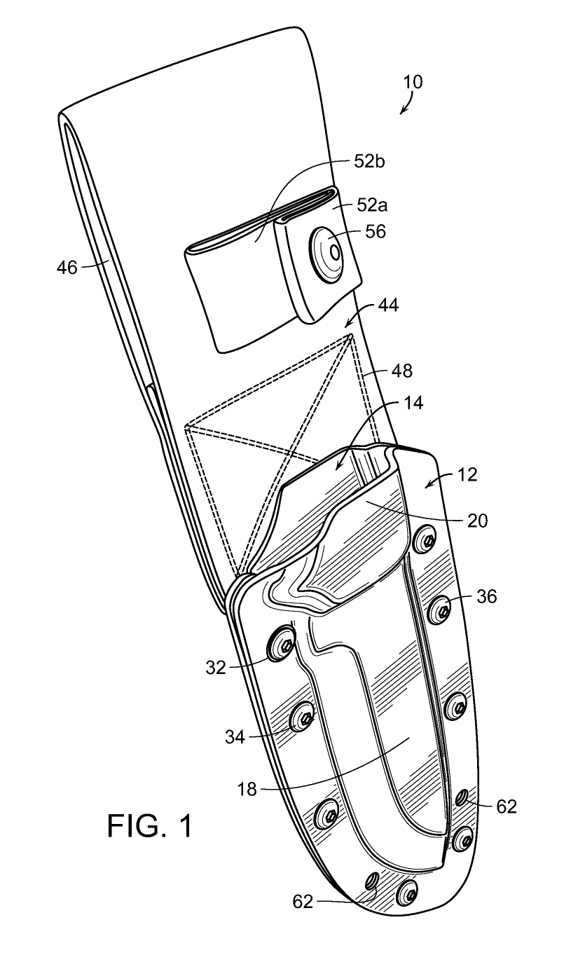

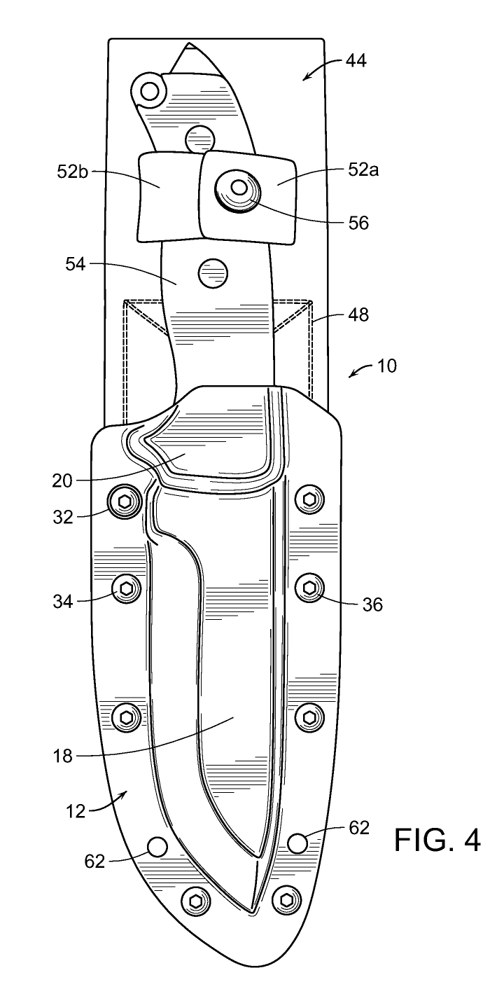

A sheath assembly 10 embodying the present invention is illustrated in FIGS. 1-5. The sheath assembly 10 comprises at least one sheet of material molded to a general configuration of the object to be removably inserted therein, the illustrated preferred embodiments herein being directed to a knife sheath assembly 10. As illustrated in FIGS. 1-5, the knife sheath assembly 10 embodying the present invention is comprised of first and second sheets of material 12 and 14 comprising a front panel 12 and a back panel 14. The sheets of material 12 and 14 may be single layer or multi-layer in composition. The first (front) and second (back) sheets 12 and 14 are comprised of a moldable material, such as a thermoplastic material or the like. A thermoplastic acrylic-polyvinyl chloride material, sold under the trade name Kydex, is particularly preferred as it allows the sheath assembly 10 to be durable and withstand the rigorous conditions it may be subjected to in a military, hunting or other similar setting.

The front and back sheets 12 and 14 may be formed to the shape of at least a portion of a knife 16 so as to keep the knife 16 secured in the sheath 10 and to prevent the knife 16 from rattling within the sheath 10 during movement. The front and back sheets 12 and 14 are preferably molded to the shape of at least a portion of the knife 16 to be sheathed within the sheath assembly through a vacuum forming process and/or thermoforming process or the like. The molded portion of the sheets 12 and 14 may include a blade molding cavity 18 and a knife guard molding cavity 20 which correspond with a blade 22 of the knife 16 and a guard 24 of the knife 16.

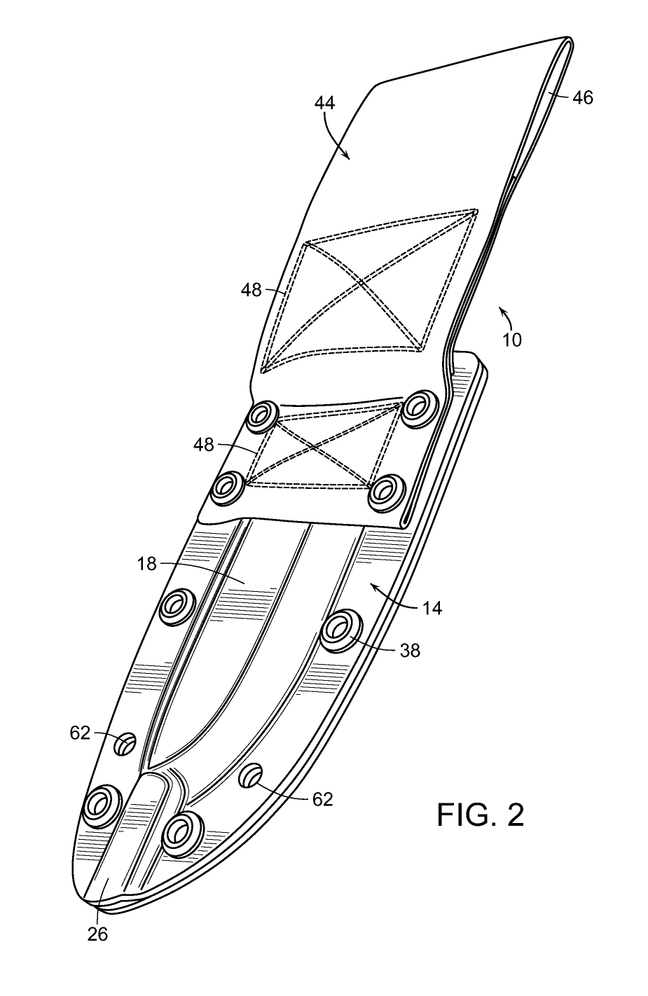

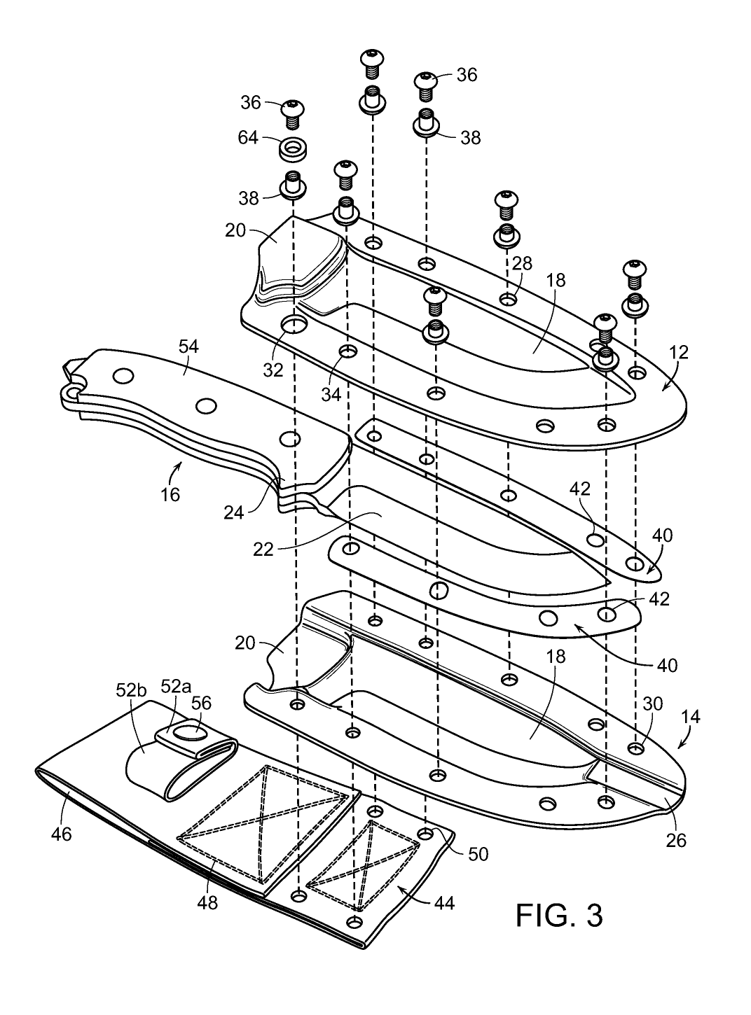

A channel drain 26, as illustrated in FIGS. 2 and 3, may also be molded into at least one of the sheets of material 12 and/or 14 during the molding process. The drain channel 26 extends from the knife blade cavity molding 18 to outside of the sheath assembly 10 for removing water and debris from the knife blade cavity 18. The drain channel 26 helps to maintain the sharp edge of the knife blade 22 by allowing water or debris, which may enter the sheath 10, to passively be removed from the sheath 10. This is advantageous in that if debris were allowed to collect within the sheath 10, the debris would abrade the blade 22 of the knife 16, dulling it as the knife 16 is removed and reinserted into the sheath 10.

A plurality of apertures 28 is formed in the first or front sheet 16 that surround the blade molding cavity 18 adjacent to a peripheral edge of the sheet 12. Similarly, a plurality of apertures 30 are formed in the second or back sheet 14 surrounding the blade molding cavity 18 and adjacent to a peripheral edge thereof. The apertures 28 and 30 are substantially aligned with one another as the first and second sheets 12 and 14 are brought into alignment and contact with one another for assembly. Two of the apertures, the hinge aperture 32 and the tension aperture 34, have different functions than the others and will be discussed in more detail below.

The front and back sheets 12 and 14 are joined together with a plurality of detachable fasteners. Such fasteners may be in the form of male fasteners 36 and female fasteners 38 configured to extend through the aligned apertures 28 and 30 and clamp or bind the sheets of material 12 and 14 therebetween. The fasteners 36 and 38 are preferably Chicago screws, sometimes referred to as post and screw, wherein the post portion of the female fastener 38 is internally threaded and the male 36 screw portion is externally threaded and threadedly attached to one another. A built-in feature, such as a slot or hex recess, aids in tightening and loosening the fasteners 36 and 38 to one another.

The incorporation of the selectively detachable fasteners 36 and 38 enable the sheath assembly 10 of the present invention to be selectively disassembled and reassembled. This can be used advantageously to clean or maintain the sheath assembly 10, and/or repair and replace component parts as necessary. In this manner, if a component, such as one or both of the sheets of molded material 12, 14 are cracked or otherwise damaged, that single component, such as the single sheet of molded material 12 or 14, can be replaced instead of the entire sheath assembly 10.

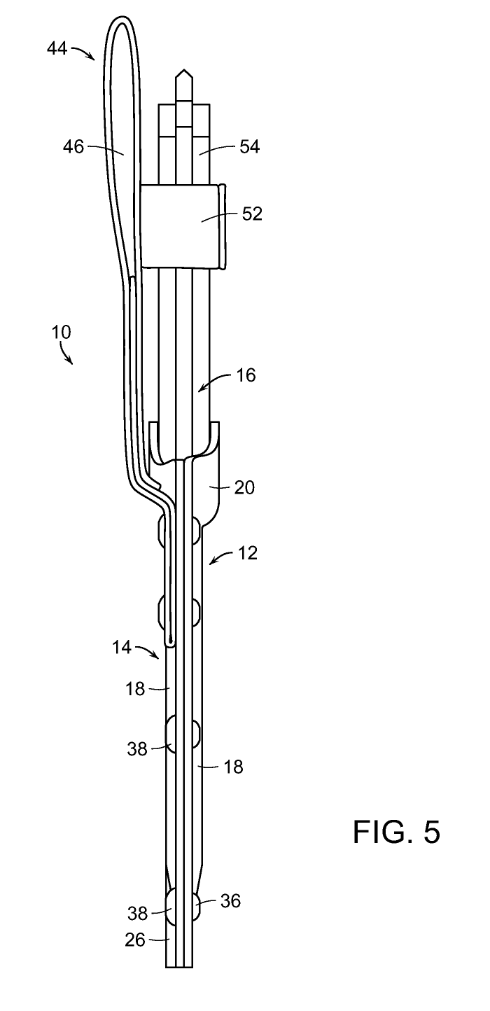

Referring specifically to FIGS. 2 and 5, the molding of the blade cavity 18 and the channel drain 26 preferably extend outwardly beyond the female fasteners 38. This feature provides the back sheet 14 with a generally flat surface, allowing the back sheet or panel 14 to rest against the leg when the sheath assembly 10 is worn, preventing the fasteners 38 from digging into the leg and causing discomfort.

Referring specifically to FIG. 3, shims 40 are preferably disposed between the front and back sheets 12, 14. The shims 40 are preferably comprised of a metal, such as stainless steel, and line the sheath 10 around the blade cavity molding 18. The shims 40 include a plurality of apertures 42 which generally align with the apertures 28 and 30 of the front and back sheets 12, 14 so that the fasteners 36 and 38 extend therethrough. If the sheets 12, 14 happen to crack when subjected to cold or other harsh conditions, the shims 40 function to hold the sheath 10 together and to keep the knife 16 secured in the sheath 10.

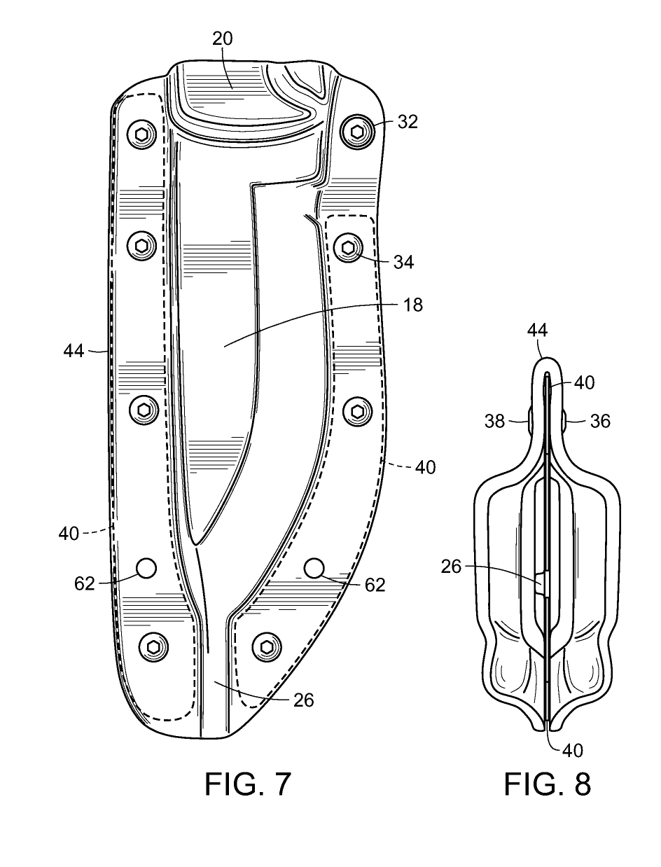

With reference now to FIGS. 7 and 8, a folded sheath embodiment is shown. In this embodiment, a single sheet of material is folded and molded to create the knife blade cavity 18, knife guard cavity 20, channel drain 26, etc. The piece of thermoplastic material or the like is folded in half to create front and back panels. This one-piece folded embodiment still contains all of the features as described above, including the shims 40, apertures, fasteners 36 and 38.

With reference again to FIGS. 1-6, a webbing assembly 44 may be connected to the molded sheath, such as the rear portion or back sheet or panel 14 and used to connect the molded sheath to a belt or military webbing or the like. The webbing assembly 44 is preferably comprised of a nylon webbing material or the like, such as, for example, approximately three inches in length, which is folded upon itself to form a belt loop 46. The length of the webbing material and the size of the belt loop 46 may vary as needed. The material for the webbing assembly 44 may be secured in the folded position by box “X” stitching 48 which functions as a stiffening agent to the webbing assembly 44.

Apertures 50 are formed in the webbing assembly 44 for connection to the sheath, such as being generally aligned with the apertures 28 and 30 of the first and second sheets 12, 14 of the sheath so that the fasteners 36 and 38 extend therethrough and fasten and connect the webbing assembly 44 to the sheath. Typically, the webbing assembly 44 contains four such apertures to allow it to be connected to the sheath. In some instances, however, an individual may not want the webbing assembly 44 to be attached to the sheath and so it may be removed, as illustrated in FIGS. 7 and 8.

A handle strap 52 may be secured to the outside of the belt loop 46 portion of the webbing assembly 44. The handle strap 52 may be a looped piece of nylon which is connected to the webbing assembly 44, such as by box “X” stitching or the like. A shorter end 52a and a longer end 52b of the handle strap 52 extend around a handle 54 of the knife 16 and are secured in place, such as by a snap 56 or other fastener. The shorter end remains on the outside when the handle strap 52 is closed, and faces backwards. This is useful in that when a soldier or hunter is moving through brush, the shorter end 52a will be less likely to catch on brush and open.

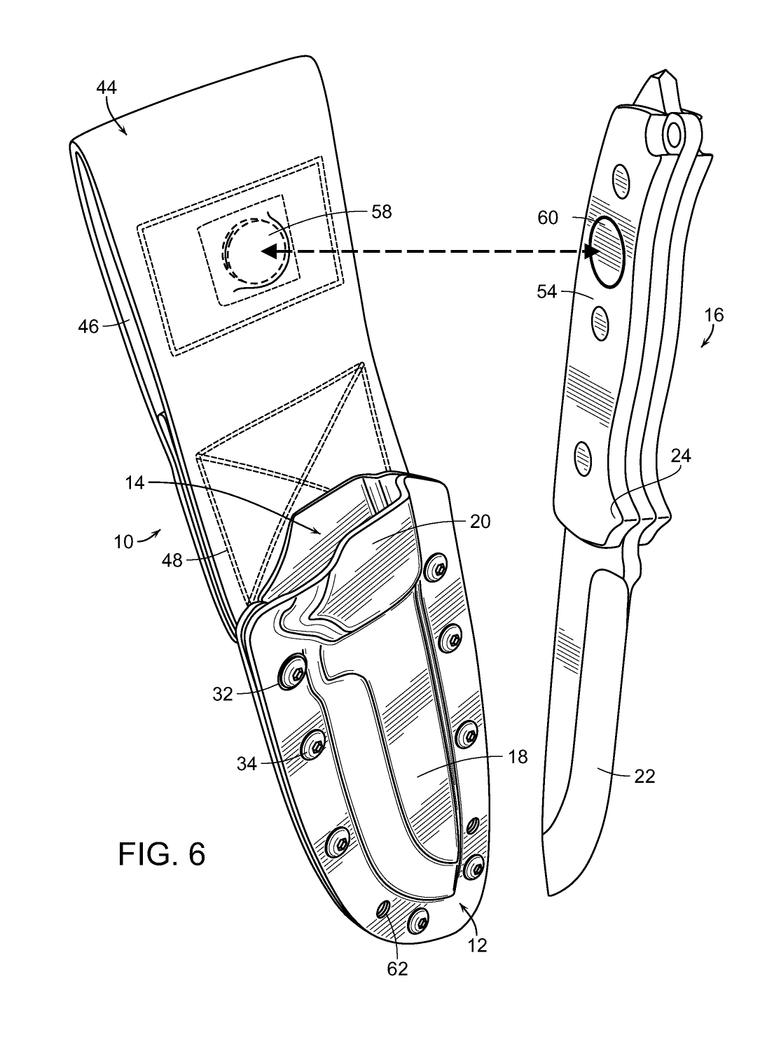

As an alternative, or in addition to, the strap connector 52 described above for the knife handle 54, a magnet connection may be used. As illustrated in FIG. 6, the belt loop portion 46 of the webbing assembly 44 may contain a magnet 58 which engages with a magnetically attractive portion of the knife handle 54, such as a magnet 60 in the handle 54 of the knife 16. An advantageous feature of this means of connection is that if the knife handle 54 does become disconnected by being knocked loose when the wearer is going through brush or crawling on the ground, it will remain close enough to the webbing assembly 44 so that the magnets 58 and 60 will almost immediately reattach.

The number of apertures 28, 30 may be greater than the number of fasteners 36, 38, leaving one or more aligned apertures without a fastener extending therethrough. These empty apertures can then become lanyard apertures 62 which allow for a cord or lanyard (not shown) to be woven through in order to further secure the sheath assembly 10 to the body, such as a leg of the user. Other than placing fasteners in the hinge aperture 32 and the tension aperture 34, the placement of the remainder of the fasteners is not crucial. The user may choose which aperture should become lanyard apertures 62 and which apertures should have fasteners placed through them.

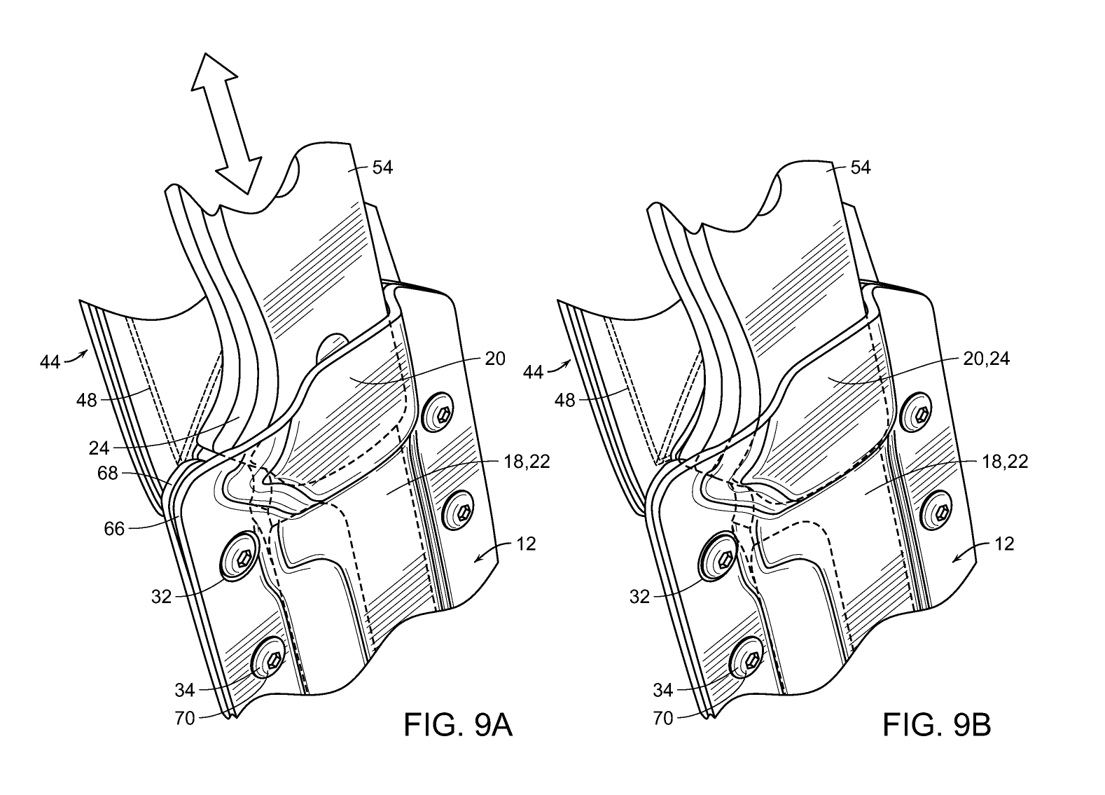

With reference now to FIGS. 9A and 9B, a normally closed hinge is formed adjacent to the knife guard cavity 20 which opens as the knife guard 24 portion of the knife 16 is inserted into or removed from the knife guard cavity 20. This hinge is comprised of the hinge aperture 32, a washer 64 (shown in FIG. 3) and the sheets of material or flaps adjacent to the knife guard cavity moldings 20. As can be seen in FIG. 3, the hinge aperture 32 is larger in diameter than the other apertures, and is also larger in diameter than the head of the male fastener 36. Consequently, when the sheath 10 is assembled, the fasteners 36 and 38 do not secure the front sheet or outward panel or sheet to the rest of the sheath, but allow a portion of the front sheet or panel, in the form of a flap 66, to be free to flex open. The knife guard cavity molding 20 is designed in such a way so as to fit firmly around the knife guard 24 when the knife 16 is in place within the sheath. Accordingly, the flap 66 of the front panel or sheet 12 must flex open in order for the knife guard 24 to enter from the outside of the knife guard cavity 20 to the inside thereof, as illustrated in FIG. 9A, wherein adjacent flaps 66 and 68 of the at least one sheet of molded material flex open as the knife 16, and particularly the knife guard 24 portion of the knife 16, is removed or inserted into the knife guard cavity 20. However, once the knife guard 24 is in place in the knife guard cavity 20, as illustrated in FIG. 9B, the front flap 66 snaps back shut adjacent to the back sheet flap 68, as illustrated in FIG. 9B. In this manner, the hinge helps to secure the knife 16 when the knife 16 is carried in the sheath 10. The knife may be removed with positive thumb pressure, ensuring safe carry as well as rapid and safe deployment.

A tension fastener 70 extending through the tension aperture 34 may be adjusted, such as by loosening the fastener 70 to allow the user to fit the knife more easily into the sheath, or it may be tightened to further secure the knife 16 in the sheath 10. The tension fastener 70 may be used to control how freely the flap 66 of the front panel or sheet 12 may flex open and snap shut.

The foregoing detailed description of preferred embodiments of the general principles of the invention as applied to a knife sheath assembly is not to be taken in a limiting sense. Rather, it should be understood that the general principles of the invention may also be applied to gun holsters, tool holsters, and the like.

Although several embodiments have been described in detail for purposes of illustration, various modifications may be made without departing from the scope and spirit of the invention. Accordingly, the invention is not to be limited, except as by the appended claims.

What is claimed is:

1. A sheath assembly, comprising:
at least one sheet of material molded to a general configuration of a blade and a guard of a knife so as to create contiguous knife blade and knife guard cavities for removably receiving the knife blade and a knife guard therein; and
a shim disposed between layers of the material.

2. The sheath assembly of claim 1, including a series of spaced apart apertures formed in the material adjacent to a peripheral edge thereof, and detachable fasteners extending through at least a plurality of the apertures.

3. The sheath assembly of claim 2, wherein the shim has apertures alignable with the apertures of the material.

4. The sheath assembly of claim 2, wherein there are fewer fasteners than apertures.

5. The sheath assembly of claim 1, including a normally closed hinge formed adjacent to the knife guard cavity that opens as the knife guard is inserted into or removed from the knife guard cavity.

6. The sheath assembly of claim 5, wherein the hinge comprises adjacent flaps of material having aligned apertures and a fastener extending therethrough permitting separation of the flaps as the knife guard is inserted into or removed from the knife guard cavity.

7. The sheath assembly of claim 1, including a drain channel extending from the knife blade cavity to outside of the sheath assembly for removing debris from the knife blade cavity.

8. The sheath assembly of claim 1, wherein the at least one sheet of material comprises first and second sheets of molded material having alignable apertures adjacent to a peripheral edge thereof and detachably connected to one another with fasteners disposed through the apertures.

9. The sheath assembly of claim 1, wherein the sheet of material comprises a single sheet of material folded and molded to create the knife blade and knife guard cavities and having fasteners removably extending through apertures formed adjacent to a peripheral edge of overlapping sections of the sheet.

10. The sheath assembly of claim 1, including a webbing assembly detachably connected to the molded material and having a loop for insertion of a belt.

11. The sheath assembly of claim 10, wherein the webbing assembly includes a connector for coupling a handle of a knife to the webbing assembly.

12. The sheath assembly of claim 11, wherein the connector comprises a strap detachably connecting knife handle to the webbing assembly.

13. The sheath assembly of claim 11, wherein the connector comprises a magnet associated with the webbing assembly that couples a magnetically attractive portion of the knife handle to the webbing assembly.

14. The sheath assembly of claim 1, wherein the at least one sheet of material comprises a thermoplastic material or the like.

15. The sheath assembly of claim 1, wherein the shim is comprised of a metal.

16. A sheath assembly, comprising:
at least one sheet of thermoplastic material or the like molded to a general configuration of a blade and a guard of a knife so as to create contiguous knife blade and knife guard cavities for removably receiving a knife blade and a knife guard therein;
a series of spaced apart apertures formed in the material adjacent to a peripheral edge thereof; and
detachable fasteners extending through at least a plurality of the apertures.

17. The sheath assembly of claim 16, including at least one shim disposed between layers of the material and having apertures alignable with the apertures of the material for receiving the fasteners therethrough.

18. The sheath assembly of claim 17, wherein the at least one shim is comprised of metal.

19. The sheath assembly of claim 16, including a normally closed hinge formed adjacent to the knife guard cavity that opens as the knife guard is inserted into or removed from the knife guard cavity.

20. The sheath assembly of claim 19, wherein the hinge comprises adjacent flaps of material having generally aligned apertures and a fastener extending therethrough permitting separation of the flaps as the knife guard is inserted into or removed from the knife guard cavity.

21. The sheath assembly of claim 16, including a drain channel extending from the knife blade cavity to outside of the sheath assembly for removing water or debris from the knife blade cavity.

22. The sheath assembly of claim 16, wherein there are fewer fasteners than apertures.

23. The sheath assembly of claim 16, wherein the at least one sheet of material comprises first and second sheets of thermoplastic material or the like having alignable apertures adjacent to a peripheral edge thereof and detachably connected to one another with fasteners disposed through the apertures.

24. The sheath assembly of claim 16, wherein the sheet of material comprises a single sheet of thermoplastic material or the like folded and molded to create the knife blade and knife guard cavities and having fasteners removably extending through apertures formed adjacent to a peripheral edge of overlapping sections of the sheet.

25. The sheath assembly of claim 16, including a webbing assembly detachably connected to the molded material and having a loop for insertion of a belt.

26. The sheath assembly of claim 25, wherein the webbing assembly includes a connector for coupling a handle of a knife to the webbing assembly.

27. The sheath assembly of claim 26, wherein the connector comprises a strap detachably connecting knife handle to the webbing assembly.

28. The sheath assembly of claim 26, wherein the connector comprises a magnet associated with the webbing assembly that couples a magnetically attractive portion of the knife handle to the webbing assembly.
